(19) United States
(12) Patent Application Publication
(10) Pub. No.: US 2007/0222316 A1
(43) Pub. Date: Sep. 27, 2007

(54) Electric Machine

(76) Inventor: Christof Bernauer, Hundsbach (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/596,594

(22) PCT Filed: Mar. 9, 2005
(86) PCT No.: PCT/EP05/51034

§ 371 Date: Nov. 15, 2006

(30) Foreign Application Priority Data
May 29, 2004 (DE) 10 2004 026 403.1

(51) Int. Cl. H02K 1/17

(52) U.S. Cl. 310/154.22; 310/154.25

(57) ABSTRACT

An electric machine, having an armature including an armature lamination that supports a winding and having a housing that accommodates at least one magnet, which is embodied at least in the form of an annular magnet segment. The armature lamination protrudes axially beyond the at least one magnet. This has the advantage of permitting the electric machine to be more compactly designed, thus permitting an appreciable reduction in costs.

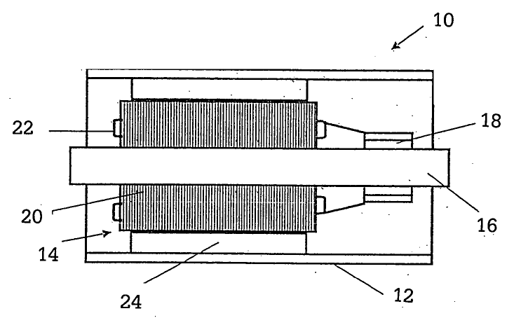

### PRIOR ART

The invention is based on an electric machine as generically defined by the preamble to claim 1.

Permanently excited direct current motors have permanent magnets, which, in the axial direction, are longer than or at least the same length as the laminated core situated opposite them. In commutator motors, this laminated core is the armature or rotor; in brushless motors, it is the stator lamination. In most cases today, permanent magnets made of hard ferrite are used for so-called “automotive” applications. As a rule, these magnets are significantly longer than the laminated core in order to generate additional flux in the motor.

With the use of high quality, expensive magnetic materials such as NdFeB or plastic-bonded NdFeB, very high magnetic flux densities occur in the iron lamination. When these high flux densities are taken into account, they lead to saturation phenomena and therefore to very high magnet costs. If the iron cross section in the laminated core is correspondingly enlarged in order to avoid these saturation effects, then only a small amount of winding space is left for the motor winding. This leads to a larger motor volume and therefore also leads indirectly to higher motor costs.

### ADVANTAGES OF THE INVENTION

The electric machine according to the present invention, with the defining characteristics of claim 1, has the advantage over the prior art of permitting the electric machine to be more compactly designed, thus permitting an appreciable reduction in costs. This is achieved through the use of a shorter permanent magnet. Through suitable geometric design, on the one hand it is possible to provide a sufficient amount of winding space for the motor winding and on the other hand, to nevertheless avoid saturation effects in the laminated core.

Suitable dimensioning of the laminated section of the armature or stator permits the flux generated by the permanent magnet to “spread” over the entire axial length of the laminated core although it was previously assumed that this would not work. Measurements have shown, however, that the flux is actually distributed in the axial direction. This permits narrower tooth bases to be provided, which then makes it possible to provide a larger groove cross section and therefore more winding space.

To this end, the electric machine has an armature including an armature lamination, which supports a winding, and a housing that contains at least one magnet, which is embodied at least in the form of an annular magnet segment; the armature lamination protrudes beyond the magnet at least in the axial direction.

For optimum spreading of the magnetic flux, it has turned out to be advantageous if the magnet is axially aligned with the center of the armature lamination.

The axial length of the magnet is embodied as a shorter than the axial length of the armature lamination. Preferably, the length of the armature lamination minus the length of the magnet corresponds to a factor comprised of the thickness of the magnet multiplied by an arbitrary number between 1 and 8, preferably between 1.5 and 5. Preferably, the magnet length is 1 to 8 mm shorter than the armature lamination, i.e. in contrast to the conventional “magnet projection”, the magnet has an “undercut” on each side of 0.5 to 4 mm. It has turned out to be particularly advantageous for the magnet to be 3 to 5 mm shorter than the laminated core.

The shortening of the magnet makes particular sense when using rare earth magnets, in particular NdFeB magnets or plastic-bonded NdFeB magnets.

Other advantages and advantageous modifications ensue from the dependent claims and the specification.

### DRAWING

An exemplary embodiment of the invention is shown in the drawing and will be explained in detail in the subsequent description.

The sole FIGURE shows a longitudinal section through an electric machine.

### DESCRIPTION OF THE EXEMPLARY EMBODIMENT

The electric machine 10 in the FIGURE is part of a drive unit that is, in particular, used in a motor vehicle. The drive unit can be a power window unit, a sunroof drive unit, a power train adjuster, a seat adjusting drive unit of a car seat adjuster, a fan, a pump, or the like.

The electric machine 10 preferably includes a rolled housing 12 in which an armature 14 is positioned with a bearing, not shown. The armature 16 includes a shaft 16 equipped with a commutator 18. The shaft 16 supports an armature lamination 20 equipped with a winding 22 that is connected to the commutator 18. The armature lamination 20 is a stamped and bundled laminated composite. Alternatively, it would also be conceivable for it to be comprised of “SMC” material (soft magnetic composite).

The housing 12 accommodates an annular magnet 24. Alternatively, it could also contain two or more shell-shaped magnets. If two magnet shells were to be provided in typical fashion, which would then be annular magnet segments, then these magnet shells would each enclose an angle of 120°, for example, on the circumference and would be situated diametrically opposite from each other in the housing 12. The annular magnet 24 is a rare earth magnet, in particular an NdFeB magnet or plastic-bonded NdFeB magnet.

The armature lamination 20 protrudes axially beyond the annular magnet 24. Ideally, the dimension of this overhang of the armature lamination 20 has turned out to be:
length of armature lamination 20−length of magnet 24=a*thickness of magnet 24,
where a is an arbitrary number between 1 and 8, preferably between 1.5 and 5. The magnet 24 is 1 to 8 mm thick, for example.

The armature lamination 20 is 1 to 8 mm longer than the annular magnet 24; preferably, the armature lamination 20 is 3 to 5 mm longer than the annular magnet 24. The annular magnet 24 is axially aligned with the center of the armature lamination 20.

1-7. (canceled)

8. In an electric machine, having an armature including an armature lamination that supports a winding and having a housing that accommodates at least one magnet, which is embodied at least in the form of an annular magnet segment, the improvement wherein the armature lamination protrudes axially beyond the at least one magnet.

9. The electric machine according to claim 8, wherein the at least one magnet is axially aligned with the center of the armature lamination.

10. The electric machine according to claim 8, wherein the length of the armature lamination minus the length of the magnet equals α·l, wherein l is the thickness of the magnet and where α is an arbitrary number between 1 and 8, preferably between 1.5 and 5.

11. The electric machine according to claim 9, wherein the length of the armature lamination minus the length of the magnet equals α·l, wherein l is the thickness of the magnet and where α, is an arbitrary number between 1 and 8, preferably between 1.5 and 5.

12. The electric machine according to claim 8, wherein the armature lamination is 1 mm to 8 mm longer than the at least one magnet.

13. The electric machine according to claim 9, wherein the armature lamination is 1 mm to 8 mm longer than the at least one magnet.

14. The electric machine according to claim 10, wherein the armature lamination is 1 mm to 8 mm longer than the at least one magnet.

15. The electric machine according to claim 11, wherein the armature lamination is 1 mm to 8 mm longer than the at least one magnet.

16. The electric machine according to claim 8, wherein the armature lamination is 3 mm to 5 mm longer than the at least one magnet.

17. The electric machine according to claim 9, wherein the armature lamination is 3 mm to 5 mm longer than the at least one magnet.

18. The electric machine according to claim 10, wherein the armature lamination is 3 mm to 5 mm longer than the at least one magnet.

19. The electric machine according to claim 12, wherein the armature lamination is 3 mm to 5 mm longer than the at least one magnet.

20. The electric machine according to claim 8, wherein the at least one magnet is a rare earth magnet, in particular an NdFeB magnet or plastic-bonded NdFeB magnet.

21. The electric machine according to claim 9, wherein the at least one magnet is a rare earth magnet, in particular an NdFeB magnet or plastic-bonded NdFeB magnet.

22. The electric machine according to claim 10, wherein the at least one magnet is a rare earth magnet, in particular an NdFeB magnet or plastic-bonded NdFeB magnet.

23. The electric machine according to claim 12, wherein the at least one magnet is a rare earth magnet, in particular an NdFeB magnet or plastic-bonded NdFeB magnet.

24. The electric machine according to claim 16, wherein the at least one magnet is a rare earth magnet, in particular an NdFeB magnet or plastic-bonded NdFeB magnet.

25. The electric machine according to claim 8, wherein the at least one magnet is an annular magnet.

26. The electric machine according to claim 9, wherein the at least one magnet is an annular magnet.

27. The electric machine according to claim 10, wherein the at least one magnet is an annular magnet.
